(19) United States
(12) Patent Application Publication
(10) Pub. No.: US 2002/0134010 A1
(43) Pub. Date: Sep. 26, 2002

(54) Vented plant dome

(76) Inventors: Robert C. Rohrborn JR., Manchester, NH (US); Jose Franco, Manchester, NH (US)

Correspondence Address: MESMER & DELEAULT, PLLC, 41 BROOK STREET, MANCHESTER, NH, 03104, US

(21) Appl. No.: 09/815,027

(22) Filed: Mar. 22, 2001

(51) Int. Cl. A01G 13/02

(52) U.S. Cl. 47/29.1

(57) ABSTRACT

An environment-controlling, plant-growing apparatus has a cover with a lower cylindrical portion and a top semi-spherical portion having at least one vent opening therein, and a top lid portion rotatably connected to the top semi-spherical portion. The top lid portion has a shape similar to that of the top semi-spherical portion and is sized to allow variable rotational adjustment of the aperture size of the vent opening.

### BACKGROUND OF THE INVENTION

1. Field of the Invention

The present invention relates generally to protective covers for plants such as greenhouses. Particularly, the present invention relates to protective covers for plants that have vents to enable a better environment for plant growing. More particularly, the present invention relates to protective covers for plants that are used for nursery and flower pots. Even more particularly, the present invention relates to protective covers for plants having improved light and heat reception and retention with mechanically adjustable ventilation.

2. Description of the Prior Art

Indigenous plants generally require no special attention. By definition, they are plants t hat are native to the area and are suited for the environment in which they live. However, many gardeners desire to landscape with non-native plants because of their appearance or the fruit that they bear or the attractive flowers or blossoms they produce, or desire to plant vegetable and flower gardens. Despite attempts to climatize these desired plants through hybridization, many plants still have a limited tolerance for extreme temperatures and excessively dry or moist conditions. Thus, many of these non-native plants need an environment in which these factors can be controlled.

Starting a garden by purchasing nursery plants is prohibitively expensive for many people and certainly not cost efficient for a large garden. The alternative is for the gardener to construct a hot bed enclosure for starting his or her own plants, or to use traditional greenhouses to grow non-native plants. Three elements are needed for plant growth, namely sun, heat to incubate the starting root system and soil. Accordingly, a hot bed enclosure is typically an open bottomed structure having transparent walls to allow sunlight to enter. Permanent structures are unacceptable to the small gardener who does not have space to give up year round for such an enclosure that may only be used in the Spring. Other hot bed enclosures are so bulky and cumbersome that set-up, disassembly and storage are constant problems.

There has been developed in recent years plant growing/culturing containers having a structure capable of providing favorable environments for various kinds of culture plants, or capable of growing a fresh green plant during a winter withering period for enjoying the plant as an interior plant.

U.S. Pat. No. 5,433,030 (1995, Lehman) discloses a portable, self-supporting greenhouse having a plurality of transparent, inflatable, tubular rings forming a cylindrical shaped structure. The tubular rings have a first inlet for inflating the transparent tubular rings and interconnecting passageways that allow the transparent rings to be inflated by way of the first inlet. There is at least one opaque inflatable tubular ring attached to the transparent inflatable rings forming a base for the structure. The opaque ring has a second inlet for inflating the opaque ring with a dense medium. A transparent cover is provided that has a plurality of transparent inflatable radial segments defining an annular top. The annular top is in communication with the transparent rings and has an opening and an inflatable transparent hatch positioned over the opening and removably secured to the annular top. In addition, a doorway and a door are provided in the cylindrical structure. The door has a plurality of inflatable tubular ring sections in communication with the transparent tubular rings forming the cylindrical structure. The door has a hinge and a latch to secure the door in a closed position. The doorway includes a frame of inflatable tubular columns in air communication with the transparent tubular rings.

Japanese Patent Abstract Publication No. 10056886 (1998, Minoru) discloses a closed container for cultivating a plant. The container has a cover with a dome shape. A small plug is installed through the side of the dome-shaped cover.

Japanese Patent Abstract Publication No. 9248066 (1997, Sanmei Denki KK) discloses a plant growing container having a protection case and a container base. The protection case is provided with an upper portion formed from a transparent material, a lower protection case base connected to the upper portion to shield the inside of the container, and a packing inserted between the upper portion and the lower protection case base. A housing portion and a flange portion are formed at the lower protection case base for housing the growing medium and the water supply.

U.S. Pat. No. 6,012,249 (2000, Cheney) discloses an insulated plant cover having a transparent or translucent inner cylinder that has an inner cylinder top and an inner cylinder bottom. The inner cylinder top has an inner cylinder top chimney positioned at a top distal end and an inner cylinder bottom spacer positioned circumferentially along a bottom distal end and is sealably attached thereto. The insulate plant cover further has a transparent or translucent outer cylinder that has an outer cylinder top and an outer cylinder bottom. The outer cylinder top has an outer cylinder top upper edge positioned circumferentially along a top distal end and an outer cylinder bottom lower edge positioned circumferentially along a bottom distal end. The inner cylinder is positioned within the outer cylinder. The inner cylinder bottom edge is sealably attached to the inner cylinder bottom spacer.

A disadvantage of the prior art is that none provide a domed-cover with an adjustable vent for regulating the temperature and humidity within the domed structure.

Therefore, what is needed is a domed cover for plants that has a vent for regulating the temperature and humidity within the domed environment. What is further needed is a domed cover for plants that has an adjustable vent for regulating the temperature and humidity within the domed environment of the plant. What is still further needed is a domed cover for plants that is inexpensive to make and use.

### SUMMARY OF THE INVENTION

It is an object of the present invention to provide a domed cover for plants that has a vent for retaining or venting the atmosphere within the domed cover. It is a further object of the present invention to provide a domed cover for plants that has a vent capable of being easily adjusted from a full open position to a full closed position. It is another object of the present invention to provide a domed cover for plants that has a plurality of vents that can be adjusted with a single action. It is still a further object of the present invention to provide a domed cover for plants that is inexpensive and easy to make. It is yet another object of the present invention to provide a domed cover kit for plants that has a plurality of vents and a simple mechanism for making the vent openings adjustable. It is another object of the present invention to provide a plant dome cover that is light weight, durable, stable, easy to clean, and simple and inexpensive to manufacture.

The present invention achieves these and other objectives by providing a cover having a lower cylindrical portion and a top semi-spherical portion having at least one vent opening and a top lid portion having a shape similar to the contour of the top semi-spherical portion. The top lid portion is pivotally connected to the top semi-spherical portion. The top lid portion can rotate about the pivot connection and is configured to allow variable adjustment of the vent opening in the top semispherical portion. The present invention may also include a base adapted for receiving the bottom of the lower cylindrical portion of the cover. The base has a plurality of ridges spaced to accept the wall thickness of the lower cylindrical portion. Additionally, the top lid portion may have a knob for adjusting the size of the aperture of the vent opening by rotating the top lid portion to a desired position.

### BRIEF DESCRIPTION OF THE DRAWINGS

FIG. 1 is a perspective view of the present invention showing the vent openings partially open allowing heat and moisture to escape from the plant environment.

FIG. 2 is a top view of the present invention showing the rotatable top lid portion in a closed position relative to the vent opening of the cover.

FIG. 3 is a cross-sectional view of the present invention showing the top lid portion retaining mechanism and the cover receiving grooves of the base.

FIG. 4 is a side view of the present invention showing the top lid portion in position to be attached to the top semi-spherical portion of the cover.

FIGS. 5A and 5B are cross-sectional views of another embodiment of the present invention showing alternative top lid retaining mechanisms.

FIG. 6 is a cross-sectional view of another embodiment of the present invention showing the adjustable vent portion located on the inside of the domed cover.

### DETAILED DESCRIPTION OF THE PREFERRED EMBODIMENT

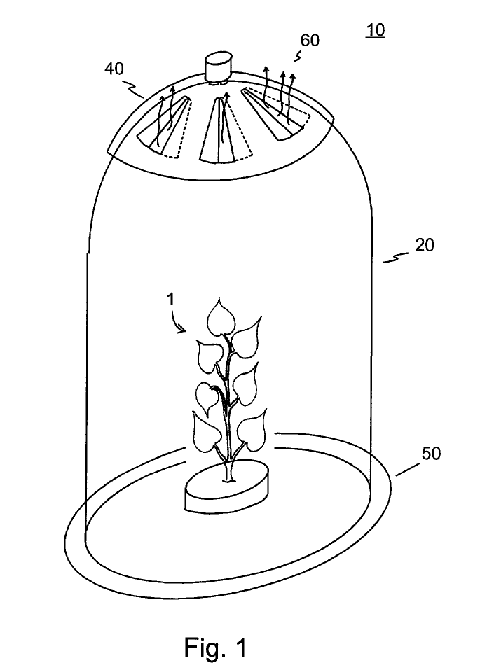

The preferred embodiment of the present invention is illustrated in FIGS. 16. FIG. 1 shows a plant encased in a plant-cultivating environment provided by the plant dome system 10 of the present invention. Plant dome system 10 includes a removable cover 20, a top lid vent portion 40 and a base 50. Plant dome system 10 has at least one vent in the top allowing heat and moisture, represented by reference 60, to escape the plant environment. Plant dome system 10 provides a system for maintaining the proper temperature and humidity for plant 1 to thrive.

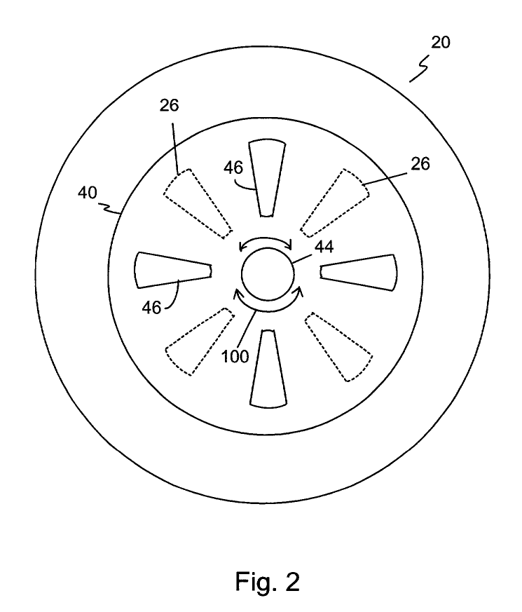

FIG. 2 shows a top view of cover 20 and top lid portion 40. Cover 20 has a plurality of vent openings 26. Cover 20 may have a single, larger vent opening or it may have a plurality of smaller vent openings, as shown, configured to allow the vents to be closed, partially open or fully open by rotation of top lid portion 40. Top lid portion 40 may include a knob 44 to facilitate the rotational movement of top lid portion 40 in either a clockwise or counterclockwise direction shown by arrows 100. Top lid portion 40 also includes a plurality of openings 46 configured relative to cover vent openings 26 to allow vent openings 26 to be fully closed, fully open or some variation between the full closed and full open position.

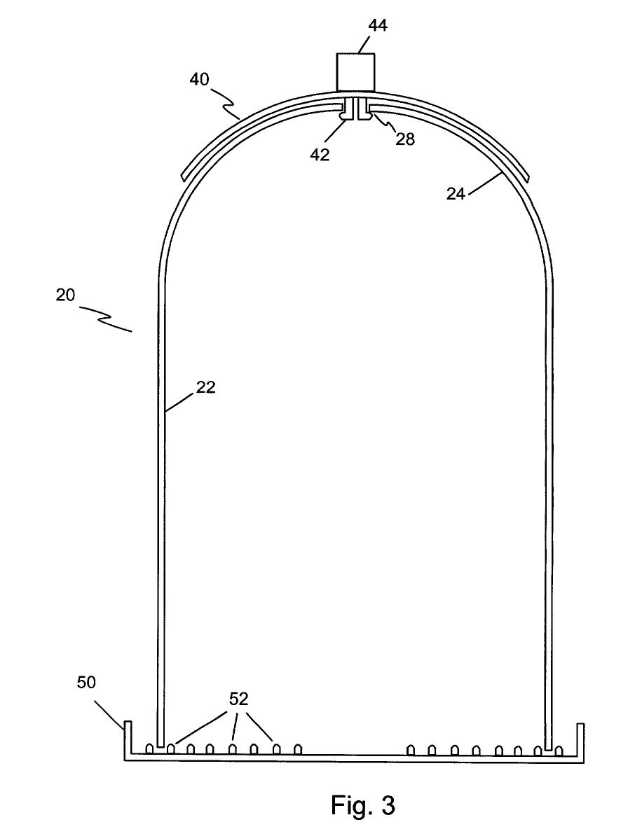

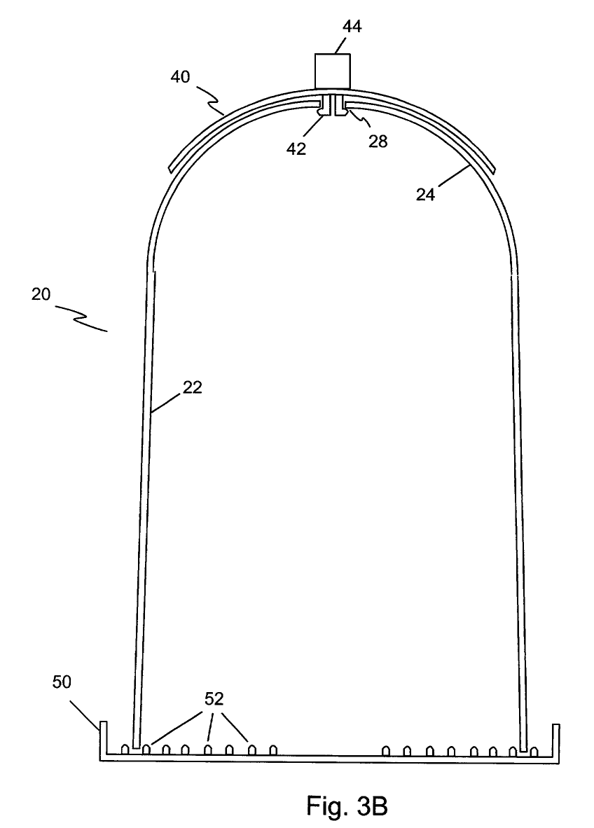

FIG. 3 is an enlarged cross-sectional view of the preferred embodiment of plant dome system 10. Cover 20 includes a lower cylindrical portion 22 and a top semi-spherical portion 24. The circumferential wall of lower cylindrical portion 22 may be perpendicular to the horizontal base 50 or may be angled, as illustrated in FIG. 3B, such that the bottom of lower cylindrical portion 22 has a larger diameter than the upper end where it meets top semi-spherical portion 24. The cone shape allows a plurality of covers 20 to be stacked, thus requiring less storage space in bulk quantities. Top semi-spherical portion 24 includes a central opening 28 for receiving the retaining mechanism 42 of top lid portion 40. Retaining mechanism 42 and top lid portion 40 may be made as a single unit, or retaining mechanism 42 may be a separate component used to secure top lid portion 40 to top semi-spherical portion 24 of cover 20. In the situation where retaining mechanism 42 is a separate component, it should be understood by those skilled in the art that top lid portion 40 will also require a central top lid opening (not shown) designed to receive retaining mechanism 42. In this situation, it is suggested that retaining mechanism 42 optionally include a knob 44. Even though retaining mechanism 42 could have a small washer-shaped top in order to prevent retaining mechanism 42 from falling through the central top lid opening, knob 44 lets the user more easily rotate top lid portion 40 to the desired vent opening position instead of handling the surface of top lid portion 40 in order to effect rotational movement. Plant dome system 10 also includes base 50. Base 50 may optionally have one or more ridges 52 for supporting a plant and for receiving the bottom end of lower cylindrical portion 22. Ridges 52 may be spaced to provide a snug fit to the bottom of cover 20. In this case, by providing base 50 with a plurality of ridges 52, base 50 is capable of supporting and snugly receiving a variety of sizes of cover 20, i.e. various diameters.

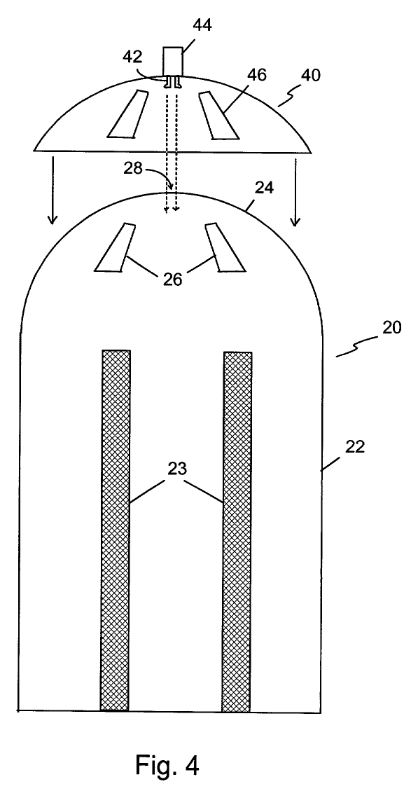

Turning now to FIG. 4, there is illustrated a side plan view of the top lid portion 40 separated from cover 20 prior to their locking engagement. Top lid portion 40 has a plurality of lid openings 46 and a retaining mechanism 42 with a knob 44. Retaining mechanism 42 and knob 44 may be integrally formed as part of the top lid portion 40. Retaining mechanism 42 may also be a separate component that is secured to top lid portion 40 by threads, a snap-fit mechanism, solvent bonding, ultrasonic bonding, gluing, a snap-lock mechanism, and the like. The type of retaining mechanism used, i.e. molding as a single unit with the top lid portion or separate pieces fitted together will most likely be determined by the cost of manufacturing. It should be understood by those skilled in the art that the top semispherical portion 24 has a central top portion receiving aperture 28 for receiving retaining mechanism 42. Receiving aperture 28 is sized to permit rotational movement of top lid portion 40 about the central axis of retaining mechanism 42 yet maintain top lid portion 40 in a semi-locked relationship with cover 20 so that top lid portion 40 cannot be easily separated from cover 20.

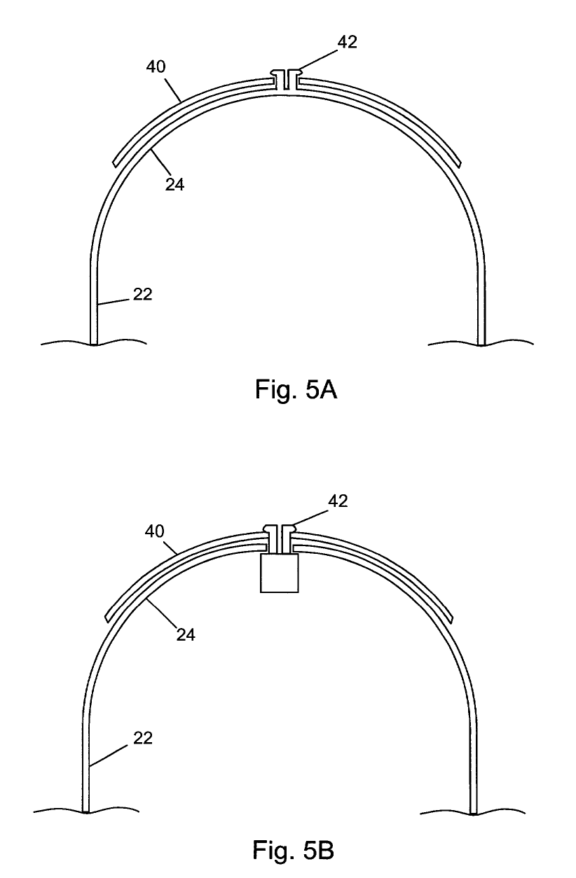

FIGS. 5A and 5B show other embodiments of retaining mechanism 42. Retaining mechanism 42 may be an integral part of cover 20, as shown in FIG. 5A, or it may be a retaining mechanism that is attached from the inside of cover 20, as shown in FIG. 5B. In each case, the top lid portion 40 may be rotated about top semi-spherical portion 24 to adjust the amount of venting of the inside of cover 20 that one desires.

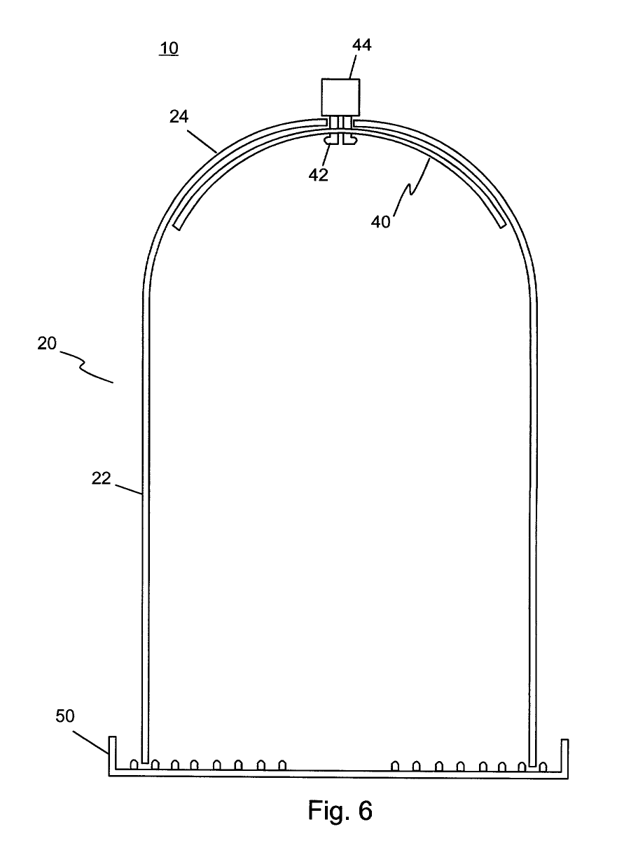

Turning now to FIG. 6, there is shown another embodiment of plant dome system 10. In this embodiment, top lid portion 40 is located inside of cover 20 up near top semi-spherical portion 24. A retaining mechanism 42 is also required to keep top lid portion 40 in close rotational relationship with top semi-spherical portion 24. In this case, retaining mechanism 42 must secure top lid portion sufficiently so that when knob 44 is turned, top lid portion 40 will rotate. This may be accomplished in a number of ways, all as is well known to those skilled in the art.

The lower cylindrical portion 22 and, optionally, the top semi-spherical portion 24 can be formed of a transparent or translucent material that allows light to pass to the plant. Alternatively, as illustrated in FIG. 4, the peripheral wall that is the lower cylindrical portion 22 can be formed with stripes or areas 23 of a darkened nature so that the heat from the sunlight is absorbed into the material of the cover 20 to enable the internal environment to achieve a higher temperature to provide a better plant germination environment. The plant dome system 10 can be manufactured with dimensions that vary according to the size of the plants to be placed within cover 20.

The present invention may be provided pre-assembled or in a kit form where the user assembles the top lid portion 40 to cover 20.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An apparatus for cultivating a plant, said apparatus comprising:
a cover comprising a lower cylindrical portion and a top semi-spherical portion, said top semi-spherical portion having at least one vent opening; and
a top lid portion having a shape similar to the contour of said top semispherical portion, said top lid portion being pivotally connected to said top portion of said cover wherein said top lid portion is configured to permit variable adjustment of said vent opening of said top semi-spherical portion.

2. The apparatus of claim 1 further comprising a base portion for supporting said cover.

3. The apparatus of claim 1 wherein said lower cylindrical wall is perpendicular.

4. The apparatus of claim 1 wherein said lower cylindrical wall is angled providing a larger diameter at the bottom of said lower cylindrical wall than the diameter at the junction between said lower cylindrical wall and said top semi-spherical portion.

5. The apparatus of claim 1 wherein said cover is transparent.

6. The apparatus of claim 1 wherein said top lid portion is transparent.

7. The apparatus of claim 1 wherein said cover has alternating darkened areas with areas of transparent or translucent material.

8. The apparatus of claim 1 further comprising a connector having a knob portion and a retaining mechanism for pivotally connecting said top lid portion to said top semi-spherical portion.

9. The apparatus of claim 2 wherein said base portion further includes at least one ringed groove sized to accept the bottom edge of said lower portion of said cover.

10. A plant-cultivating greenhouse kit comprising:
a cover comprising a lower cylindrical portion and a top semi-spherical portion, said top semi-spherical portion having at least one vent opening; and
a top lid portion having a shape similar to the contour of said top semispherical portion, said top lid portion adapted to be pivotally connected to said top portion of said cover wherein said top lid portion is configured to permit variable adjustment of said at least one vent opening of said top semi-spherical portion.

11. The kit of claim 10 further comprising a base plate adapted to support said cover.

12. The kit of claim 10 further comprising a knob retainer mechanism adapted for pivotally connecting said top lid portion to said top semi-spherical portion of said cover wherein said top lid portion is capable of rotational movement about said pivotal connection.

13. A method of making a plant cultivating apparatus comprising:
forming a cover having a lower cylindrical portion and a top semi-spherical portion with at least one vent opening and a top lid portion having a shape substantially similar to the contour of said top semi-spherical portion wherein said cover and said top lid portion have a mating connection that is a pivot point that allows said top lid portion to rotate about said pivot point; and
attaching said top lid portion to said top semi-spherical portion of said cover at said pivot point such that said top lid portion is capable of rotating about said pivot point for selectively controlling the aperture size of said at least one vent opening.
